(19) United States
(12) Patent Application Publication
(10) Pub. No.: US 2006/0019077 A1
(43) Pub. Date: Jan. 26, 2006

(54) Process

(75) Inventors: Alan John Hopper, Blackley (GB); Mark Robert James, Blackley (GB)

Correspondence Address: MORGAN LEWIS & BOCKIUS LLP, 1111 PENNSYLVANIA AVENUE NW, WASHINGTON, DC, 20004, US

(73) Assignee: AVECIA INKJET LIMITED

(21) Appl. No.: 11/168,996

(22) Filed: Jun. 29, 2005

(30) Foreign Application Priority Data
Jul. 2, 2004 (GB) 0414847.4

(51) Int. Cl. B05D 5/12; B05D 3/00; B32B 15/00

(52) U.S. Cl. 428/209; 427/96.1; 427/532; 427/256; 428/901

(57) ABSTRACT

A process for making a printed circuit board having a solder mask and area(s) of exposed metal circuitry which comprises the steps: a) applying a non-aqueous ink which is substantially free from organic solvent to a printed circuit board; b) curing the ink by exposure to actinic radiation; and c) optionally heating the ink; whereby the ink is applied to selected areas of the printed circuit board by means of an ink jet printer and wherein the ink comprises: i) a cationically curable compound; and ii) a cationic initiator.

The present invention relates to a process for making Printed Circuit Boards (also known as printed wire boards, hereinafter PCB's) having a solder mask whereby an ink is applied to the PCB by means of an ink jet printer. It also relates to PCBs made by said process.

PCB's are often complex sandwiches of numerous individual dielectric substrates containihg metal (typically copper or gold) electrically conductive circuitry on one or both sides. The joining of the PCB circuitry to itself or to other components (for example connectors, transistors, resistors, capacitors, diodes and mounts for silicon chips) is conventionally achieved by soldering. Since circuits are often narrowly spaced it is important that solder does not overspill and thus connect parts of the PCB or component's circuitry incorrectly. To attempt to prevent this possibility a solder mask is typically employed.

A conventional solder masking process usually utilises a radiation curable ink applied to the PCB surface typically by means such as screen printing or more commonly photo-lithography. A photo-tool is prepared which is a negative image of the desired solder mask pattern. The photo-tool is typically a silver halide photographic emulsion. The photo-tool is aligned correctly between a radiation source and the PCB surface. The ink on the PCB is then irradiated through the photo-tool such that only the exposed areas of the ink are cured to give the solder mask. The unexposed areas of the ink are next removed, which is generally achieved by exposure to dilute aqueous alkali. The removal step results in exposing those parts of the electrically conductive metal circuitry which it is desired to solder. The retained solder mask is often further cured by heating to temperatures typically from 120 to 160° C. The exposed metal circuitry is then typically coated with flux followed by a solder paste which is held in place by the solder mask. The solder paste can then be heated to form a liquid and then allowed to cool and solidify so making the desired connection. Other methods of soldering such as hot air solder levelling and wave soldering are also known.

The conventional process of solder masking uses more solder mask ink than is needed (because much of the ink is uncured and removed), requires a photo-tool and has many process steps.

U.S. Pat. No. 5,270,368 describes a means of applying an etch resist (rather than a solder mask ink) ink to a PCB surface by ink jet printing. U.S. Pat. No. 5,270,368 describes only radical curing ink jet etch resist inks comprising acrylate curable compounds.

The flux is often applied as a composition comprising a solvent such as iso-propyl alcohol thus solder masks also require good resistance to flux and to the solvents in flux compositions. Flux also often contains strong acids such as HCl and HBr.

Solder masks require performance characteristics above and beyond those for etch resists. Unlike an etch resist a solder mask is typically never removed and solder masks therefore tend require superior adhesion to the PCB substrate. Further, the soldering step typically involves temperatures as high as 280° C. for lead free solder or as high as 260° C. for lead containing solder which the mask should be able to survive.

Thus, there is a need for an improved process for making a PCB having a solder mask without the aforementioned disadvantages of conventional solder masking technology. In particular there is a need for a process that makes a solder mask with good adhesion, good flux resistance and good thermal resistance to soldering.

JP2003-313464A, JP2003-119414A and EPO 779 346 disclose cationic ink jet ink compositions and ink jet printing, however, there is no mention of such inks for use in the process of making a solder mask.

According to a first aspect of the present invention there is provided a process for makinga printed circuit board having a solder mask and area(s) of exposed metal circuitry which comprises the steps:
a) applying a non-aqueous ink which is substantially free from organic solvent to a printed circuit board;
b) curing the ink by exposure to actinic radiation; and
c) optionally heating the ink;
   whereby the ink is applied to selected areas of the printed circuit board by means of an ink jet printer and wherein the ink comprises:
i) a cationically curable compound; and
ii) a cationic initiator.

The process of the present invention requires inks which are non-aqueous. By the term non-aqueous it is meant that the ink is substantially free of water. Trace amounts of water (e.g. less than 0.5 parts) may be present as impurities or by-products from one of more components of the ink.

The process of the present invention requires inks which are substantially free from organic solvent. For clarification, it will be understood that the term organic solvent refers to non-curable organic solvents. Only small amounts of organic solvent may be present. It is preferred that the ink comprises not greater than 2 parts, more preferably not greater than 1 parts and especially not greater than 0.5 parts of organic solvent by weight relative to the total ink. It is much preferred that the ink is free from organic solvent.

The ink must comprise a cationically curable compound (hereinafter referred to as CCC) which is defined as a compound which can be cured by the cationic initiator. Examples of cationically curable compounds can be found in Advances in Polymer Science, 62, pages 1 to 47 (1984) by J. V. Crivello which are incorporated herein by reference thereto.

Preferably, the CCC has at least one olefin, thioether, acetal, thioxane, thietane, aziridine, N, O, S or P heterocycle, aldehyde, lactam, cyclic ester group, more preferably an O or N vinyl or allyl group and especially a cyclic ether group.

Preferable, the cyclic ether group is an epoxy or oxetane group. Preferably, the O vinyl group is a vinyl ether.

Vinyl ether, oxetane and epoxide groups are particularly effective as groups for cationic cure as they provide excellent thermal resistance and good adhesion in the final solder mask.

The CCC preferably has at least one vinyl ether, oxetane or epoxy group.

Preferred examples of CCCs having at least one vinyl ether group include ethyl vinyl ether (EVE), n-butyl vinyl ether (NBVE), isobutyl vinyl ether (IBVE), octadecyl vinyl ether (ODVE), cyclohexyl vinyl ether (CVE), butanediol divinyl ether (BDDVE), hydroxyl butyl vinyl ether (HBVE), cyclohexane dimethanol monovinyl ether (CHMVE), diethyleneglycol divinyl ether (DVE-2), triethylene glycol divinyl ether (DVE-3), n-propyl vinyl ether (NPVE), isopropyl vinyl ether (IPVE), dodecyl vinyl ether (DDVE), diethylene glycol monovinyl ether (MVE-2), cyclohexanedimethanol divinyl ether (CHDVE), 4-(vinyloxy)butyl benzoate, bis[4-(vinyl oxy)butyl]adipate, bis[4-(vinyl oxy)butyl]succinate, 4-(vinyloxy methyl)cyclohexylmethyl benzoate, bis[4-(vinyloxy)butyl]isophthalate, bis[4-(vinyloxymethyl)cyclohexylmethyl]glutarate, tris[4-(vinyloxy)butyl]trimellitate, 4-(vinyloxy)butyl steatite, bis[4-(vinyloxy)butyl]hexanediylbiscarbamate, bis[[4-(vinyloxy)methyl]cyclohexyl]methyl]terephthalate, bis[[4-(vinyloxy)methyl]cyclohexyl]methyl]isophthalate, bis[4-(vinyloxy)butyl](4-methyl-1,3-phenylene)-biscarbamate, bis[4-vinyloxy)butyl](methylenedi-4,1-phenylene) biscarbamate and 3-amino-1-propanol vinyl ether. These are available from suppliers such as BASF and Aldrich.

Preferred examples of CCCs having at least one oxetane group include 3-ethyl-3-hydroloxymethyl-1-oxetane (OXA), the oligomeric mixture 1,4-bis [3-ethyl-3-oxetanyl methoxy)methyl]benzene (XDO), 3-ethyl-3-phenoxymethyl-oxetane (POX), bis ([1-ethyl(3-oxetanil)]methyl) ether (DOX), 3-ethyl-3-[(2-ethylhexyloxy) methyl]oxetane (EHOX), 3-ethyl-[(tri-ethoxysilyl propoxy)methyl]oxetane (TESOX) which are available from Toagosei under the product names OXT 101, 121, 211, 221, 212 and 610 respectively.

A large number of CCCs having at least one epoxy group are available as listed in “Handbook of Epoxy Resins” by Lee and Neville, McGraw Hill Book Company, New York (1967) and in “Epoxy Resin Technology” by P. F. Bruins, John Wiley and Sons New York (1968) which are herein incorporated by reference.

Preferred examples of CCCs having at least one epoxy group include 1,4-butanediol diglycidyl ether, 3-(bis(gycidyloxymethyl)methoxy)-1,2-propane diol, limonene oxide, 2-biphenyl gycidyl ether, 3,4-epoxycyclohexylmethyl-3′,4′-epoxycyclohexane carboxylate, epichlorohydrin-bisphenol S based epoxides, epoxidized styrenics and more preferably epichlorohydrin-bisphenol F and A based epoxides and epoxidized novolaks.

Preferred epichlorohydrin-bisphenol A based epoxides are supplied by Resolution Performance Products under the Epoikote™ tradename. Preferred examples of which are Epikote™ 1001, 1002, 1004, 1007 and especially 1009 and 828.

One or more different CCCs can be present in the ink. Each CCC can have different types of groups for cationic cure but more preferably has groups of only one type.

Preferably, the ink comprises a CCC having one or more, more preferably two cationically curable groups.

Preferably, the CCC is oligomeric, polymeric or more preferably monomeric in nature. A monomer as defined herein includes curable compounds with alkoxylated and especially ethoxylated and propoxylated repeat units. Preferably the CCC has a number averaged molecular weight of less than 5,000, more preferably less than 3,000 and especially less than 1,000. When more than one CCC is present in the ink it is preferred that no CCC present has a number averaged molecular weight of greater than 5,000, more preferably greater than 3,000 and especially greater than 1,000.

The CCC may have a hyperbranched or dendritic molecular structure. Such structures can have a high functionality (i.e. many cationically curable groups per molecule) to enable rapid and effective cure and in addition they exhibit a reduced viscosity when compared to conventional linear or lightly branched structures. This simultaneous improvement in high functionality and low viscosity is particularly advantageous for use in ink jet inks.

A wide variety of cationic initiators exist, many examples of which can be found in the article entitled “Cationic Polymerisation” in Advances in Polymer Science, 1984, Vol 62, pages 1 to 47 by J. V. Crivello which are incorporated herein by reference. Further examples of cationic initiators can be found in the article entitled “Photoinitiators for UV and visible curing of coatings: mechanisms and properties” in the Journal of Photochemistry and Photobiology, A: Chemistry, 1996, Vol 100, part 1-3, page 105 which are also incorporated herein by reference.

The cationic initiator must be capable of initiating upon exposure to actinic radiation. The cationic initiator is capable of initiating by means of generating cationic species or more preferably (in the case of hybrid cationic initiators) by means of generating both cationic and radical species. Preferred hybrid cationic initiators include triarylsulphonium and diaryliodonium salts.

The cationic initiator is preferably capable of generating either Lewis acids (e.g. BF₃ and PF₅) or more preferably Bronsted acids (e.g. HBF₄ or HAsF₆).

Preferred cationic initiators capable of generating Lewis acids include aryidiazonium salts.

Preferred cationic initiators capable of generating Bronsted acids (often referred to as photo-acid generators) include iodonium (especially diaryl iodonium), sulphonium selenonium, triazine (especially 2-(methoxphenoyl)-4,6,-trichloromethyl-1,3,5-triazine) and sulphonate (especially phthalinidyl, camphorosulphonate and succinimidyl trifluoromethylsulphonate) salts.

Preferred sulphonium salts are triaryl sulphonium, dialkylphenylacyl sulphonium and dialky-4-hydroxyphenylsulphonium salts. Preferred specific examples include 4-isopropylphenyl-4-methylphenylsulphonium hexafluorophosphate) available from Ciba under the trade name Irgacure™ 250 and [4-{(2-hydroxytetradecyl)oxy}phenyliodonium hexafluoro antimonite (HTPIA) CAS number 139301-16-9 available from Aldrich Chemicals.

Where the cationic initiator is in the form of a salt the associated anion is preferably of medium and more preferably low nucleophilicity.

Preferred examples of anions having medium nucleophilicity include SO₄²⁻ and CF₃CO₂⁻. Preferred examples of anions having low nucleophilicity include SbF₆—, BF₄—, AsF₆⁻ and especially PF₆—.

One or more different cationic initiators can be present in the ink.

It will be understood by the term “comprising” that the ink may additionally comprise further optional ink components such as one or more radically curable compound(s), radical initiator(s), sensitiser(s), adhesion promoter(s), colorant(s) or other additives suitable for use in inks.

The ink may optionally comprise a radically curable compound (hereinafter RCC) which is defined as being a compound which is curable by a radical initiator. Inks comprising both cationically and radically curable compounds are generally referred to as “hybrid inks”. It will be appreciated by those skilled in the art that some compounds can be cured by both cationic and radical initiators. For clarity such compounds are considered to be radically curable compounds and not cationically curable compounds. Thus, for example, styrene which can be cured by both cationic and radical species is considered to be a radically curable compound. One or more radically curable compounds can be present in the ink.

The RCC preferably has at least one ethylenic (C═C) and/or acetylenic (C═C) curable group(s).

More preferably the RCCs has at least one vinyl and especially at least one acrylate group.

Preferably, the acrylate group is CH₂═C(R₁)COOR₂ wherein R, is hydrogen, alkyl (especially methyl) or cyano and R₂ is alkyl (especially C₁₋₂₀-alkyl). It is particularly preferred that the acrylate group is a methacryloyl or especially an acryloyl acrylate.

The RCC preferably has from one to three acrylate groups.

Preferably, the RCC is oligomeric, polymeric or more preferably monomeric. Preferably, the RCC has a number averaged molecular weight of less than 30,000, more preferably less than 5,000 and especially less than 3,000.

Where more than one RCC is present in the ink it is preferred that no RCC present in the ink has a number averaged molecular weight of greater than 30,000, more preferably greater than 5,000 and especially greater than 3,000.

The RCC can be polymeric and can contain hydrocarbyl groups linked by one or more heteroatoms as for example in polyethers, polyamides, urethanes, polyesters and ureas. Preferably, the RCC is compatible with the ink and does not form a separate phase.

Specific examples of RCCs having one or more acrylate groups are those which are commercially available under the Sartomer™, Actilane™ and Photomer™ trademarks for example Sartomer™ 506 (isobornyl acrylate), Sartomemm 306 (tripropylene glycol diacrylate), Actilane™ 430 (trimethylol propane ethoxylate triacrylate), Actilane™ 251 (a tri-functional urethane acrylate oligmer), Actilane™ 411 (a cyclic trimethylol propane formal mono acrylate), Photomer™ 4072 (trimethylol propane propoxylate triacrylate), Photomer™ 4039 (a phenol ethoxylate monoacrylate). Sartomer™, Actilane™ and Photomemm are trademarks of Cray Valley Inc, Akros BV and Cognis Inc, respectively. Other examples are lauryl acrylate, isodecylacrylate, iso-octyl-acrylate, butyl acrylate, 2-hydroxy ethyl acrylate, 2-hydroxy propylacrylate, 2-ethyl hexyl acrylate, 1,6-hexanediol diacrylate, neopentyl glycol diacrylate, diethylene glycol diacrylate, butanediol diacrylate, trimethylolpropane triacrylate, pentaerythritol triacrylate, 1,3-butyleneglycol diacrylate, 1,4-butylene glycol diacrylate, triethylene glycol diacrylate, penta erythritol tetra acrylate, tripropylene glycol diacrylate, isobornyl acrylate, 2-norbornyl acrylate, cyclohexyl acrylate, phenoxyethyl acrylate and tetra hydrofurfuryl acrylate. Preferred RCCs having at least one acrylate group are Sartomer™ 506 and Sartomer™ 306.

Where more than one RCC is present in the ink it is preferred that all the RCCs have one or more acrylate groups.

The ink may optionally comprise a radical initiator. This is distinguished from the hybrid cationic initiator in that the term radical initiator as used herein means only those initiators which can generate radical but not cationic species. The ink can comprise more than one radical initiator.

Where the ink comprises an RCC the ink preferably also comprises a hybrid cationic initiator (especially a triarylsulphonium and diaryliodonium salts) and/or a radical initiator. This assists in the cure of the RCC.

The radical initiator may be a thermal initiator but is preferably a photo-initiator capable of initiating upon exposure to actinic radiation and/or particle beam radiation.

Examples of suitable radical photo-initiators are α-alkoxydeoxy benzoin; α,α-dialkyloxydeoxybenzoin; α,α-dialkylacetophenone; α,α-hydroxyalkylphenone; O-acyl α-oximinoketone; dibenzoyl disulphide; S-phenyl thiobenzoate; acyl and bis acyl phosphine oxide; acetophenone; dibenzoylmethane; phenylazo-4-diphenylsulphone; benzophenone; camphorquinone; fluorenone; xanthone (of the O or S type); thioxanthone; benzyl; α-ketocoumarin; anthraquinone; ketal; quinone and terephthalophenone photo-initiators.

Preferred anthraquinones are alkyl, aryl and halogen substituted anthraquinones for example 2-tert butyl anthraquinone, 1-chloroanthraquinone, p-chloroanthraquinone, 2-methylanthraquinone, 2-ethylanthraquinone, octamethyl anthraquinone and 2-amylanthraquinone,

Preferred quinones are optionally substituted polynuclear quinones for example 1,4-naphthoquinone, 9,10-phenanthraquinone, 1,2-benzanthraquinone, 2,3-benzanthraquinone, 2-methyl-1,4-naphthoquinone, 2,3-dichloronaphthoquinone, 1,4-dimethylanthraquinone, 2,3-dimethylanthraquinone, 2-phenylanthraquinone, 2,3-diphenylanthraquinone, 3-chloro-2-methylanthraquinone, retenequinone, 7,8,9,10-tetrahydronapthaanthraquinone, 1,2,3,4-tetrahydro benzanthracene-7.2-dione.

Preferred acetophenones are acetophenone, 2,2-dimethyoxy-2-phenyl acetophenone, 2,2-diethoxy-2-phenyl acetophenone, 1,1-dichloro acetophenone, 1-hydroxy cyclothexyl-phenylketone and 2-methyl-1-(4-methylthio)phenyl-2-morpholin-propan-1-one).

Preferred thioxanthones are 2-methylthioxanthone, 2-decylthioxanthone, 2-dodecylthioxanthone, 2-isopropylthioxanthone, 2,4-dimethylthioxanthone, 2,4-diethylthioxanthone, 2-chlorothioxanthone, 1-chloro-4-propoxythioxanthone and 2,4-diisopropylthioxanthone.

Preferred ketals are dimethylketal and dibenzylketal.

Preferred benzoins are benzoin, benzyl benzoin methyl ether, benzoin isopropyl ether and benzoin isobutyl ether.

Preferred benzophenones are benzophenone, methylbenzophenone, 4,41-dichlorobenzophenone, 4,4′-bis-diethyl amino benzophenone Preferred commercially available radical photo-initiators are Irgacure™ 184, 369, 907, 2959 and 1850, Darocure™ 1173 and especially Speedcure™ DETX, ITX, CTX and CPTX. Irgacure™ and Darocure™ are registered trademarks of Ciba Gmbh. Speedcure™ is a registered trademark of Lambson Fine Chemicals Ltd.

In the case where an RCC is present in the ink it is preferred that the ink comprises two or more radical photo-initiators. More preferably at least one of the two or more radical photo-initiators is a thioxanthone radical initiator. It is especially preferred that the ink comprises Speedcure™ ITX and Darocure™ 1173.

Preferred thermal initiators are peroxides and azo compounds.

The ink may optionally comprise a sensitizer (also sometimes referred to as an initiator synergist) to assist the cationic initiator and/or the optional radical initiator.

Preferred sensitizers for cationic initiators are polycyclic aromatic, phenothiazine, hindered amines and especially amino benzoate sensitizers.

Preferred commercially available sensitizers for cationic initiators are Speedcure™ BEDB, DMB, EDB and especially EHA available from Lambson Fine Chemicals Ltd.

Preferred polycyclic aromatic sensitizers include anthracene derivates such as 2-ethyl-9,10-DiMethoxy-Antracene (ED MA) and 9-hydroxy-methylanthracene (H MA) available from Aldrich Chemicals

Preferably, the ink comprises both a thioxanthone radical initiator (especially Speedcdre™ ITX) and an amino benzoate sensitizer (especially Speedcure™ EHA).

The ink may optionally comprise an adhesion promoter. The adhesion promoter is any organic compound which contains an adhesion promoting group which can assist in the adhesion of the ink to the metal surface of the PCB circuitry and/or the surface of the dielectric substrate.

The adhesion promoting group can be a hydroxide; amine; or mercaptan group, any of which may be aliphatic, aryl or heteroaryl.

Preferably, the adhesion promoting group is a ketoximine; acetarylamide; hydroxy silane or silicone; aryl or heteroaryl hydroxide (e.g phenolic hydroxide); N-containing heterocycle (e.g as imidazole, benzimidazole, triazole, benztriazole, thiazole, isothiazole); acid anhydride; β-diketone, β-keto ester, β-keto aldehyde β-keto heterocycle group; or an acid group (especially carboxylic acid, phosphonic acid and sulphonic acid group).

Where the adhesion promoter contains more than one adhesion promoting group these may be the same or different. Preferably, the adhesion promoter has two adhesion promoting groups and preferably these two adhesion promoting groups are attached to adjacent carbon atoms. Preferred examples of such adhesion promoting groups are α-diketone, α-keto ester, α-keto aldehyde and α-keto heterocycle groups.

Commercially available examples of adhesion promoters include Actilane™ 276 (tetra functional urethane acrylate), Actilane™ 320 HD 20 (difunctional epoxy acrylate), Actilane™ 340 (trifunctional epoxy acrylate), Actilane™ 505 (tetrafunctional polyester acrylate), MEM (acetoacetoxy ethylmethacrylate), Photomer™ 5424 (acid functional oligomer), Photomemm 4173 (acidic adhesion promoter), Photomer™ 4846 (low acid value adhesion promoter), Photomer™ 5429 (a polyester tetra acrylate), Actilane™ 820 (difunctional acrylate), Actilane™ 872 (difunctional acrylate), Actilane 890 (pentafunctional melamine acrylate), Photomer™ 5004F (silane acrylate), Sartomer™ 3050 (acidic monoacrylate), mono-2-(methacryloyloxy) ethyl succinate, bis(2-methacryloxy)ethylphosphate, Photomer™ 4703 (acidic adhesion promoter), 2-hydroxy-3-phenoxy propyl acrylate and diurethane dimethacrylate. Actilane™, Photomer™ and Sartomer™ are trade names of Akros BV, Cognis Inc and Cray Valley Inc, respectively.

The ink can comprise one or more adhesion promoters. Each adhesion promoter can have one or more adhesion promoting groups. The adhesion promoter can have no groups which are capable of curing with other components of the ink, however it is more preferred that the adhesion promoter has at least one group which is curable by either the cationic and/or the optional radical initiator. It is preferred that the adhesion promoter has only one group which is curable with the cationic and/or the optional radical initiator.

Preferably, the adhesion promoter has a cationically curable group and/or an acrylate group as defined hereinbefore and more preferably an acryloyl acrylate group.

Preferred adhesion promoters exhibit acid values of no more than of 100, more preferably no more than 50 and especially no more than 25 mg KOH/g. We have found that adhesion promoters with low acid values tend to show better storage stability in the inks for use in the present invention than those with higher acid value. This is especially so where the ink comprises a CCC having an epoxy or oxetane group.

The adhesion promoter may be oligomeric or polymeric but is preferably monomeric in nature.

The precise chemical structure of adhesion promoters available under commercial trade names is not known but from the description of the products they are believed to contain hydroxy and/or carboxylic acid groups. Many of these commercially available adhesion promoters are derived from diols and polyols which are esterified by reaction with (meth)acrylic acid and consequently they may contain free (meth)acrylic acid. This free (meth)acrylic acid may be the actual adhesion promoter. However, for the purpose of the invention commercial mixtures containing free (meth)acrylic acid are to be regarded as single compounds, especially regarding their acid values.

The ink may optionally comprise a colorant. The colorant is preferably a dye or more preferably a pigment. The ink can comprise one or more colorants.

The ink can be of any colour but preferably the ink is green, blue or red in colour. This includes all shades of green, blue or red.

The ink may optionally comprise any additive suitable for use in inks and especially those suitable for ink jet inks. Such additives include wax, dispersant, dispersant synergist, anti-foaming, surfactant, bactericide, fungicide, rheology modifier, filler, levelling, gloss, anti-static, binder and inhibitor additives. The ink can comprise more than one additive.

Preferably, the surfactant is one comprising silicon or fluoro atoms.

Preferably, the surfactant has at least one group which is curable by either cationic and/or radical initiators. More preferably the surfactant has at least one acrylate group.

Preferred surfactants are Tegorad™ available from Tego Chemie Service GmbH. Preferred examples of which are Tegorad™ 2100 and 2200.

Hydroquinone and hydroquinone monomethyl ether are a particularly preferred as inhibitors for free radical cure.

Acid scavengers may also be incorporated into the ink to help prevent premature curing.

Where the ink comprises a filler and/or a pigment it is preferred that the ink additionally comprises a dispersant. Preferably the amount of dispersant present in the ink is from 5 to 200%, more preferably from 10 to 150% and especially from 30 to 100% based on the total weight of pigment and/or filler. Preferred dispersants are those under the tradename Solsperse™ available from Lubrizol. A dispersant synergist may be used to assist the dispersant.

The PCB can comprise metal circuitry of any conductive metal. Preferably, the metal in the PCB circuitry is gold or, more preferably, copper.

The ink jet printer used to apply the ink in step a) can be continuous but is more preferably of the Drop-on-Demand (D-o-D) type. The ink jet printer is preferably a piezo or thermal ink jet printer. The placement, number and size of the ink jet droplets can be controlled so as to control the thickness of the ink applied to the PCB. The temperature of the ink during ink jet printing can be as high as 150° C., however the temperature is preferably from 25 to 65° C.

Ink jet printing of the selected areas of the PCB is achieved by means of computer control of the ink jet printer and by means of imaging and driver software.

It will be realised that because the invention relates to a process for making a PCB having a solder mask that the selected areas of the PCB for application of the ink are the metal circuitry, where soldering is not desired, and preferably much of the PCB dielectric laminate. This is in contrast to legend printing where a legend ink is applied to areas which are somewhat distanced from circuits/components and which does not reside on the metal circuitry surface. Commonly, the legend is applied on top of the solder mask which is itself on top of the dielectric laminate distanced from the metal circuitry.

In step b) the ink on the PCB is cured by exposure to actinic radiation. Suitable sources of actinic radiation include mercury lamps, xenon lamps, carbon arc lamps, tungsten filament lamps, lasers and sunlight. Preferably, the actinic radiation is Ultraviolet (UV) radiation. UV radiation is preferably that emitted by medium pressure mercury lamps which may be doped for example H and V lamps.

The cure resulting from step b) may be partial and may result in for example a tacky solder mask. Step b) can be performed once or it may be repeated a number of times to further cure the solder mask.

In the case of partial cure resulting from step b), step c) (heating the ink) is preferably included.

In many cases the PCB formed by the process of the present invention has superior properties when heating step c) is performed. Heating the ink tends to drive the cure of the solder mask further and results in solder masks with better adhesion, hardness and resistances to solder/flux and reducing agents.

Where the ink is heated in step c) the temperature is preferably from 50 to 300° C. or more preferably 80 to 200° C. Preferably the duration of heating is from 1 to 180 minutes or more preferably from 15 to 180 minutes. Heating can be achieved by any suitable means. Preferred methods for heating the ink on the PCB include hot air (especially oven heating), radiant heating (especially infra red), inductive heating and contact heating (e.g using a hot roller).

In some applications it is preferable to metal plate at least some of the area(s) of exposed metal circuitry.

A preferred additional process step is d) metal plating one or more area(s) of the exposed metal circuitry. Preferably, such metal plating is achieved by immersion, electrolytic or more preferably by electroless metal plating utilising a reducing agent.

Electroless metal plating typically utilises strong reducing agents to reduce a metal ion present in solution and deposit said metal onto any area(s) of exposed metal circuitry in the PCB. Electroless plating tends to be performed under acidic, basic or neutral pH conditions. The exact conditions will depend on many factors but will largely be influenced by the metal being plated down. The pH can be as high as 13 or as low as 3. The electroless plating process is often carried out at elevated temperatures which can be as high as 95° C. We have found that the reducing agents and/or the pH/thermal conditions used in electroless plating tend to aggressively attack known ink jet inks which are free radical curing and acrylate based. Whilst the mechanism of such attack is not understood the visible observation when a free radical cured acrylate based solder mask is exposed to typical electroless plating conditions is that the solder mask disintergrates and/or delaminates. It is speculated that the poor performance of free radical curing and acrylate based ink to electroless plating may be a result of aqueous hydrolysis and/or of chemical attack by the reducing agents used.

Preferred types of reducing agents include hypophosphite, hydrazine based, thiourea based, borohydride, amine borane and aldehyde/amine borane agents. Preferred examples of which are sodium hypophosphite monohydrate, sodium borohydride, diemthyl borane, diethylamine borane, hydrazine hydrate and thiourea.

We have found that the process of the present invention provides PCBs having a solder mask which demonstrates good resistance to the pH/thermal conditions and reducing agents used in electroless plating.

We have found that ink jet inks wherein the CCC has at least one vinyl ether, oxetane or epoxy group provide a cured solder mask which demonstrates further improved resistance to the process of electroless plating.

Preferably, the ink comprises a CCC having at least one vinyl ether group and a CCC having at least one epoxy group. Such inks demonstrate further improved resistance to the process of electroless plating.

More preferably the ink comprises a CCC having at least one vinyl ether group, a CCC having at least one epoxy group and a CCC having at least one oxetane group. Such inks demonstrate yet further improved resistance to the process of electroless plating.

The ink may comprise more than one CCC having a particular type of group.

The process of the present invention also provides PCBs having a solder mask which has good resistance to electrolytic plating on, for example, Cu, Sn, Au, Ag and Ni metal substrates.

Immersion metal plating uses the electrochemical displacement of a metal ion in solution by a more electropositive metal in a metallic surface. For example when copper metal is in contact with an aqueous tin (II) solution the copper surface will become rapidly plated by the deposition of metallic tin as some of the copper metal reacts to give copper (II) in solution. Immersion plating is typically carried out under basic conditions or more frequently acidic aqueous conditions. In the case of acidic conditions the pH can be as low as 3 to 4 (e.g. gold dip immersion plating). As with electroless plating the temperatures used in immersion plating can be as high as 95° C. The metal in the metallic surface is typically a much weaker and less aggressive reducing material than the reducing agents used in electroless plating. That said the ink faces similar (if significantly milder) performance challenges to resist the immersion plating process plating as it does in the electroless metal plating process. Thus, the aforementioned preferences in respect of electroless plating apply equally to immersion plating.

We have found that inks containing significant amounts of acid groups tend to be less stable on storage especially where the CCC has epoxy or oxetane groups. Such a storage stability problem is seen primarily in poorer ink jet firing.

It is preferred that no component of the ink has an acid value of greater than 100 mg KOH/g. It is also preferred that the ink comprises no more than 10%, more preferably no more than 5%, especially no more than 2% and most especially no more than 1% by weight relative to the total ink of any component having an acid group. A preferred ink for use in the present invention comprises:
i) 0.1 to 99.9 parts of cationically curable compound; and
ii) 0.01 to 20 parts of cationic initiator;
   wherein all parts are by weight.

Preferably, the amount of CCC in the ink is from 1 to 99 parts, more preferably from 10 to 99 parts, especially from 50 to 99 parts and most especially from 70 to 99 parts by weight.

Preferably, the amount of cationic initiator in the ink is from 0.1 to 15 parts, more preferably from 1 to 10 parts and especially from 1 to 5 parts by weight.

Preferably, the sum of the parts of components i) and ii) is 100 parts, more preferably the sum of the parts of components i) and ii) including any optional ink components in 100.

Preferably, the amount of RCC in the ink is from 0 to 70 parts, more preferably from 0.1 to 20 parts and especially from 1 to 15 parts by weight.

Incorporation of relatively small amounts of RCC (less than 20 parts by weight) into the ink helps to further reduce the ink viscosity and aid the ink jet firing without adversely reducing the resistance of the cured solder mask to soldering temperatures or electroless metal plating conditions.

The amount of radical initiator in the ink is preferably from 0.01 to 20 parts, more preferably from 1 to 10 parts and especially from 1 to 5 parts by weight.

The amount of sensitizer in the ink is preferably from 0.1 to 20 parts, more preferably from 1 to 10 parts and especially from 2 to 8 parts by weight.

Preferably, the amount of adhesion promoter in the ink is from 0.1 to 30 parts, more preferably 0.1 to 20 parts and especially from 0.1 to 10 parts by weight.

The amount of colorant in the ink is preferably from 0.1 to 25 parts, more preferably from 1 to 20 parts and especially from 1 to 10 parts by weight. Lower amounts of colorant are preferred because they can be cured more effectively and readily.

Preferably, the total amount of all the additives in the ink is from 0.01 to 30 parts, more preferably from 0.1 to 25 parts and especially from 0.1 to 20 parts by weight.

The amount of surfactant in the ink is preferably from 0.01 to 10 parts, more preferably from 0.1 to 5 parts and especially from 0.1 to 2 parts by weight.

We have found that specific combinations of different types of CCC provide inks which result in solder masks which demonstrate excellent solder resistance (in addition to the aforementioned advantages).

Preferably, the ink comprises at least one CCC having at least one vinyl ether group and at least one CCC having at least one epoxy group, more preferably the ink comprises at least one CCC having at least one vinyl ether group, at least one CCC having at least one epoxy group and at least one CCC having at least one oxetane group. A preferred ink comprises:
a) from 0.9 to 99 parts, more preferably from 29 to 70 parts of a cationically curable compound having at least one vinyl ether group;
b) from 0.9 to 99 parts, more preferably from 29 to 70 parts of a cationically curable compound having at least one epoxy group; and
c) from 0.1 to 20 parts, more preferable from 1 to 10 parts of cationic initiator;
wherein the ink has a viscosity of less than 200 mPa·s at 40° C. and all parts are by weight. Preferably the sum of the parts a) to c) is 100 parts, more preferably the sum of parts a) to c) including any optional ink components is 100 parts.

Such inks provide solder masks which demonstrate good resistance to electroless and immersion plating, good ink jetting performance and good resistance to the thermal conditions of soldering.

A more preferred ink comprises:

a) from 0.4 to 99 parts, more preferably from 20 to 70 parts of a cationically curable compound having at least one vinyl ether group;
b) from 0.4 to 99 parts, more preferably from 20 to 70 parts of a cationically curable compound having at least one epoxy group;
c) from 0.4 to 99 parts, more preferably from 20 to 70 parts of a cationically curable compound having at least one oxetane group; and
d) from 0.01 to 20 parts, more preferable from 1 to 10 parts of cationic initiator; wherein the ink has a viscosity of less than 200 mPa·s at 40° C. and all parts are by weight. Preferably the sum of the parts a) to d) is 100 parts, more preferably the sum of the parts a) to d) including any optional ink components is 100 parts.

Such inks provide solder masks which exhibit further improvements in solder resistance.

We have found that inks comprising at least one hydrophobic CCC are especially useful in the process of the present invention. In particular such inks provide improved solder resistance to the solder mask.

The hydrophobicity of any CCC can be characterised by its LogP value. LogP is the logarithm (base 10) of the partitioning co-efficient of the CCC between n-octanol and water as described in L. G. Danielsson and Y. H. Zhang, Trends in Anal. Chem, 1996,15, 188. High LogP values signify hydrophobic compounds and low LogP values signify hydrophilic compounds. LogP values can be calculated which are in good agreement with experimental determinations (Analytical Sciences September 2002, Vol 18, pages 1015 to 1020). Thus, in such cases either experimental or calculated methods can be used to establish LogP values.

The inventors prefer to use a calculated LogP value to be taken as the definitive value.

Calculated LogP values are also preferred because commercial computer programmes exist which can accurately and quickly calculate the LogP values of large numbers of real or hypothetical compounds.

The hydrophobicity of the CCC is preferably determined by calculating the LogP value using ACD Labs v7.0 software or later versions thereof. Table 1 summarises the LogP values obtained for a range of CCCs.

Preferably, the ink comprises at least one CCC having a LogP value of at least 2, more preferably at least 2.5, especially at least 3 and most especially at least 3.5. The preferred upper limit for LogP values is 6.

A preferred hydrophobic ink comprises:
i) a cationically curable compound; and
ii) a cationic initiator
   wherein at least one of the cationically curable compound(s) present in the ink has a LogP value of at least 2 and the ink has a viscosity of less than 200 mPa·s at 40° C.

It is more preferred that all of the CCCs present in the ink provide a weight averaged LogP value of at least 2, more preferably at least 2.3 and especially at least 2.5.

The weight averaged LogP value is calculated by equation (1):
LogP=W₍ᵢ₎LogP₍ᵢ₎ (1)

wherein W₍ᵢ₎ is the weight fraction of each CCC present based on the total amount of CCCs present in the ink and LogP₍ᵢ₎ is the LogP value for each CCC. By example, using the data provided in Table 1 an ink comprising only two CCCs, namely 10 parts of OXT-212 and 10 parts Celluloxide™ 2021, would have a weight averaged LogPvalue of (10/20×4.09+10/20×1.78) i.e. 2.935.

TABLE 1

| | | LogP |
|---|---|---|
| CCC | Structure | (ACD Labs v.7.0) |
| CHDVE | 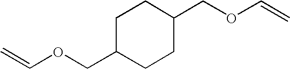 | 2.81 |
| DVE-3 | 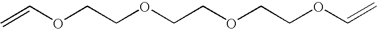 | 0.45 |
| OXT-221 | 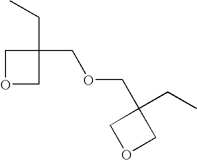 | 1.19 |
| OXT-101 | 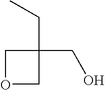 | −0.08 |
| OXT-212 | 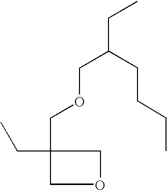 | 4.09 |
| Epikote 828 | 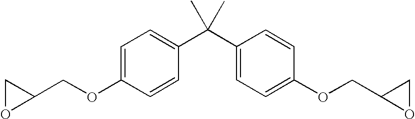 | 3.95 |
| Celloxide 2021 | 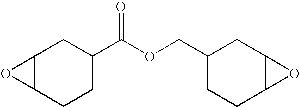 | 1.78 |
| Celloxide 3000 | 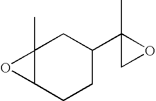 | 0.30 |

Thus, a preferred ink comprises:
i) a cationically curable compound; and
ii) a cationic initiator
   wherein all of the CCC(s) present in the ink provide a weight averaged LogP value of at least 2 and the ink has a viscosity of less than 200 mPa·s at 40° C.

It will be realised that the advantages of inks comprising a two or more CCC's having different groups as described above (epoxy, oxetane, vinyl ether) can be combined with the advantages regarding hydrophobicity and LogP values.

The ink preferably has a viscosity of less than 200 mPa·s (cPs), more preferably less than 100 mPa·s (cPs) and especially less than 30 mPa·s (cPs) at a temperature of 40° C. Preferably, the ink has a viscosity of from 1 to 30 mPa·s (cPs) at a temperature of 40° C.

The ink preferably has a surface tension of from 20 to 40 and especially between 25 and 35 mN/m. Consequently, the amount of surfactant is generally from 0.1 to 0.6 parts by weight.

Preferably, the ink has been filter through a filter having a pore size of 10 microns, more preferably 5 microns and especially 1 micron.

It is more preferred that the ink has been filtered by cascade filtration wherein the ink composition passes through successively finer filter media, for example, 10, 6, 4.5, 2.5 and 1.2 micron filters.

The inks used in the process of the present invention may also be used as a legend ink and as a permanent etch resist ink.

According to a second aspect of the present invention there is provided a PCB having a solder mask obtainable by the process according to the first aspect of the present invention wherein the ink comprises:
a) from 20 to 70 parts of a cationically curable compound having at least one vinyl ether group;
b) from 20 to 70 parts of a cationically curable compound having at least one epoxy group;
c) from 20 to 70 parts of a cationically curable compound having at least one oxetane group; and
d) from 1 to 10 parts of cationic initiator; wherein the ink has a viscosity of less than 200 mPa·s at 40° C. and all parts are by weight.

There is further provided a PCB having a solder mask obtainable by a process according to the first aspect of the present invention wherein one or more area(s) of the exposed metal circuitry have been subsequently metal plated. Preferably, the metal plating is achieved by immersion or more preferably electroless metal plating utilising a reducing agent.

The present invention is also provides a PCB having solder mask obtainable by a process according to the first aspect of the present invention wherein the ink comprises at least two different CCCs, all of the CCCs present in the ink provide a weight averaged LogP value of at least 2. More preferably the weight average LogP is at least 2.3 and especially at least 2.5. Preferably, the ink in such an embodiment comprises a mixture of CCCs as hereinbefore described.

The invention is further illustrated by the following examples wherein all references are to parts by weight unless expressed to the contrary.

### EXAMPLE 1

### Making a Coated Dielectric Board

Step (I): Preparation of Colorant Millbases Cyan Millbase 1 and Yellow Millbase 1

The components down each column of Table 2 were used to prepare millbases for use in the preparation of the inks.

The colorant (1) or (2) was mixed with the radically curable compounds (3) and (4), the dispersant (5) and (if present) the dispersant synergist (6). The mixture was then milled for of 16 hrs using 3 mm balatini glass beads by means of a horizontal shaker. After milling the glass beads were filtered off resulting in the colorant millbases Cyan millbase 1 and Yellow millbase 1.

TABLE 2

| Component | Cyan millbase 1 | Yellow millbase 1 |
|---|---|---|
| Colourant | | |
| (1) Irgalite Blue ™ GLVO | 25.00 | — |
| (2) Paliotol ™ yellow D1819 | — | 20.00 |
| Radically curable compound | | |
| (3) Sartomer ™ 506 | 29.75 | 37.00 |
| (4) Sartomer ™ 306 | 29.75 | 37.00 |
| Dispersant | | |
| (5) Solsperse ™ 32,000 | 15.00 | 6.00 |
| Dispersant synergist | | |
| (6) Solsperse ™ 5,000 | 0.5 | — |

(1) Irgalite Blue GLVO is a cyan coloured copper pthalocyanine, pigment blue 15:4, pigment available from Ciba gmbh,
(2) Paliotol ™ yellow is a isoindoline based pigment yellow 139 available from BASF.

Step (II): INK 1 (Preparation of a Solder Mask Ink for Use in Ink Jet Printing)
Stage 1

The cationically curable compounds, Rapi-cure CHVE (43.6 parts), Oxetane OXT-221 (20.0 parts) and Epikote™ 828 (30.0 parts) were mixed together at 25° C. to form a reactive mixture. N.B Rapi-cure™ CHVE is actually CHDVE available from International Speciality Products.

Stage 2

The reactive mixture prepared in stage 1 was mixed with Cyan millbase 1 (1.5 parts), the Yellow millbase 1 (0.5 parts) and the surfactant Tegorad™ 2100 (0.4 parts). This gave a green coloured reactive mixture.

Stage 3

The green reactive mixture prepared in stage 2 was mixed with the radical initiator Darocure™ 1173 (1.0 part) and the cationic initiator Irgacure™ 250 (3.0 parts).

Stage 4

The mixture resulting from stage 3 was then cascade filtered through a series of filters having a pore size of 10, 6, 4.5, 2.5 and 1.2 microns. This resulted in Ink 1.

Step (III): Tests on Ink 1

The viscosity of Ink 1 was measured at 45° C. using a Brookfield Viscometer equipped with a spindle number 18 rotating at 100 rpm.

The surface tension of Ink 1 was measured at a temperature of 25° C. using a DuNoy ring.

Step (IV): Preparation of Dielectric Boards Having a Cured Solder Mask

Ink 1 was printed onto uncoated dielectric FR4 boards laminated with 30 μm thick copper sheet on the surface of the FR4 boards. The Ink 1 was applied to a thickness of approximately 25 μm by means of a Xennia print rig fitted with a Xaar XJ500 print head. The ink was then cured by passing the printed dielectric boards under a UV Fusion D bulb running at 120 W/cm with an energy output of 300 to 900 MJ/cm at a speed of 10 to 35 m/min. After UV curing the ink was additionally thermally cured by heating the dielectric boards to 150° C. for 60 minutes in a fan assisted oven. This resulted in dielectric/copper sheet laminate boards having a cured solder mask on the copper sheet surface.

Step (V): Testing of Dielectric Boards Having a Cured Solder Mask

The pencil hardness of the solder mask was assessed using IPC test method TM 2.4.27.2 of IPC-TM-650. High hardness pencil values indicate harder solder masks.

The adhesion of the solder mask to the copper surface of the dielectric board was measured using ASTM test method D3359-87 and given a rating of 0 (poor) to 5 (excellent).

The resistance of the cured solder mask to hot solder was measured by applying flux containing 40% rosin to the surface of the solder mask and immersing the dielectric board in a solder bath at a temperature of 260° C. for 10 seconds according to test method 3.7.2 of IPC-SM-840C. The results are given by a visual rating on a scale of 0 (poor) to 5 (excellent).

The dielectric strength of the solder mask was measured as per IPC-SM-840C. Higher values indicate better insulating properties.

Step (VI): Results

The solder mask made in step (IV) had the following properties shown in Table 3:

TABLE 3

| Properties | |
|---|---|
| Viscosity @ 45° C. (cps) | 12.8 |
| Pencil Hardness | 8H |
| Adhesion on copper | 4 |
| Resistance to solder | 5 |
| Dielectric strength | 5.25 |
| (kV/25 micron) | |

The results in Table 3 show that the dielectric boards having a solder mask made by the process according to the present invention had excellent resistance to solder, good adhesion and good hardness.

### Example 2

### Quick Testing of Inks Suitable for Use in The Present Invention

Application Method

In order to more speedily demonstrate and contrast a series of inks and the properties they provide as a solder mask the following inks were applied by means of a K-bar as opposed to ink jet printing. The viscosity and surface tension of all the inks applied via the K-bar was such that they would be suitable for use in an ink-jet printer.

Step (I): Preparation of Inks 2 to 8 and Comparative Ink 1

Inks were prepared having the formulations described in Table 4 by Stages a) to e) below:

Stage a)

The cationically curable compounds (1) to (4), the radically curable compounds (6) and (7) and the adhesion promoters (12) and (13) were mixed together by stirring at approximately 25° C. for 1 hr. This resulted in a reactive mixture.

Stage b)

The millbases (14) and (15) were then added to the reactive mixture resulting from stage a).

Stage c).

The cationic initiator (5), the radical initiators (8) to (10) and the sensitizer (11) were mixed in the dark with the above mixture resulting from stage b).

Stage d)

The surfactant (16) and the inhibitor (17) were mixed with the above mixture resulting from stage c).

Stage e)

The mixture resulting from stage d) was then cascade filtered through a series of filters having pore sizes of 10, 6, 4.5, 2.5 and 1.2 microns respectively. This resulted in the Inks 2 to 8 and Comparative ink 1.

TABLE 4

| | | | | | | | | Comp |
|---|---|---|---|---|---|---|---|---|
| Component | Ink 2 | Ink 3 | Ink 4 | Ink 5 | Ink 6 | Ink 7 | Ink 8 | Ink 1 |
| Type (Acrylate = A, vinyl | VE/E, | O/A, | VE/A, | VE/A, | VE/A, | VE/A, | VE/A, | A |
| ether = VE, oxetane = O, | | | | | | | | |
| epoxy = E,) | | | | | | | | |
| Cationically curable | | | | | | | | |
| compound | | | | | | | | |
| (1) Triethyleneglycol | 46.8 | | | | | | | |
| divinyl ether | | | | | | | | |
| (2) Cyclohexane | | | 20.0 | 25 | 20.0 | 20.0 | 20.0 | |
| dimethanol divinyl ether | | | | | | | | |
| (3) Epikote ™ 1009 | 46.8 | | | | | | | |
| (4) OXT-221 | | 20.0 | | | | | | |
| Cationic Initiator | | | | | | | | |
| (5) Irgacure ™ 250 | 3.0 | 2.0 | 2.0 | 2.0 | 2.0 | 2.0 | 2.0 | |
| Radically curable | | | | | | | | |
| compound | | | | | | | | |
| (6) Satromer ™ 506 | | 50.6 | 50.6 | 45.6 | 50.6 | 45.6 | 45.6 | 63.65 |
| (7) Satromer ™ 306 | | | | | | | | 12.04 |
| Radical Initiator | | | | | | | | |
| (8) Irgacure ™ 369 | | 4.0 | 4.0 | 4.0 | 4.0 | 4.0 | 4.0 | 2.0 |
| (9) Darocure ™ 1173 | 1.0 | | | | | | | |
| (10) Speedcure ™ ITX | | 2.0 | 2.0 | 2.0 | 2.0 | 2.0 | 2.0 | 2.0 |
| Sensitizer | | | | | | | | |
| (11) Speedcure ™ EHA | | 4.0 | 4.0 | 4.0 | 4.0 | 4.0 | 4.0 | 4.0 |
| Adhesion Promoter | | | | | | | | |
| (12) Acrylic acid | | | | | | 5.0 | 5.0 | |
| (13) Photomer ™ 5429 | | 15.0 | 15.0 | 15.0 | 15.0 | 15.0 | 15.0 | 12.0 |
| Colorant | | | | | | | | |
| (14) Cyan millbase 1 | 2.0 | 1.5 | 1.5 | 1.5 | 1.5 | 1.5 | 1.5 | 1.5 |
| (15) Yellow millbase 1 | | 0.5 | 0.5 | 0.5 | 0.5 | 0.5 | 0.5 | 0.5 |
| Surfactant | | | | | | | | |
| (16) Tegorad ™ 2200 | 0.4 | 0.4 | 0.4 | 0.4 | 0.4 | 0.4 | 0.4 | 0.4 |
| Inhibitor | | | | | | | | |
| (17) Hydroquinone | | | | | | 0.5 | 0.5 | |

Step (II): Preparation of Inks 9 to 17

Inks were prepared having the formulations described in Table 5. These inks had different hydrophobicities and thus varying weight averaged LogP values. Inks 9 to 17 also comprise at least one CCC having at least one vinyl ether group, at least one CCC having at least one epoxy group and at least one CCC having at least one oxetane group. These inks were prepared by stages a) to e) as described below.

Stage a)

The cationically curable compounds (1) to (4) were mixed together by stirring at approximately 25° C. for 1 hr. This resulted in a reactive mixture.

Stage b)

The millbases (7) and (8) were then added to the reactive mixture resulting from Stage a).

Stage c)

The cationic initiator (5) and the radical initiator (6) were mixed in the dark with the above mixture resulting from stage b).

Stage d)

The surfactant (9) was mixed with the above mixture resulting from stage c).

Stage e)

The mixture resulting from stage d) was then cascade filtered through a series of filters having pore sizes of 10, 6, 4.5, 2.5 and 1.2 microns respectively. This resulted in the Inks 9 to 17.

The weight averaged LogP value shown in Table 5 was calculated using equation (1).

TABLE 5

| | | Ink | Ink | Ink | Ink | Ink | Ink | Ink | Ink |
|---|---|---|---|---|---|---|---|---|---|
| Component | Ink 9 | 10 | 11 | 12 | 13 | 14 | 15 | 16 | 17 |
| Type (Acrylate = A, | VE/O/E | VE/O/E | VE/O/E | VE/O/E | VE/O/E | VE/O/E | VE/O/E | VE/O/E | VE/O/E |
| vinyl ether = VE, | | | | | | | | | |
| oxetane = O, epoxy = E) | | | | | | | | | |
| Cationically curable | | | | | | | | | |
| compound | | | | | | | | | |
| (1) Rapi-cure CHVE | 43.6 | 43.6 | 43.6 | 43.6 | 43.6 | 0.0 | 0.0 | 0.0 | 0.0 |
| (LogP = 2.81) | | | | | | | | | |
| (2) OXT 101 | 0.0 | 5.0 | 10.0 | 15.0 | 20.0 | 0.0 | 20.0 | 40.0 | 65.6 |
| (LogP = −0.08) | | | | | | | | | |
| (3) OXT 221 | 20.0 | 15.0 | 10.0 | 5.0 | 0.0 | 65.6 | 45.6 | 25.6 | 0.0 |
| (LogP = 1.19) | | | | | | | | | |
| (4) Epikote ™ 828 | 30.0 | 30.0 | 30.0 | 30.0 | 30.0 | 30.0 | 30.0 | 30.0 | 30.0 |
| (LogP = 3.95) | | | | | | | | | |
| Cationic Initiator | | | | | | | | | |
| (5) Irgacure ™ 250 | 3.0 | 3.0 | 3.0 | 3.0 | 3.0 | 3.0 | 3.0 | 3.0 | 3.0 |
| Radical Initiator | | | | | | | | | |
| (6) Irgacure ™ 1173 | 1.0 | 1.0 | 1.0 | 1.0 | 1.0 | 1.0 | 1.0 | 1.0 | 1.0 |
| Colorant | | | | | | | | | |
| (7) Cyan millbase 1 | 1.5 | 1.5 | 1.5 | 1.5 | 1.5 | 0.0 | 0.0 | 0.0 | 0.0 |
| (8) Yellow millbase 1 | 0.5 | 0.5 | 0.5 | 0.5 | 0.5 | 0.0 | 0.0 | 0.0 | 0.0 |
| Surfactant | | | | | | | | | |
| (9) Tegorad ™ 2200 | 0.4 | 0.4 | 0.4 | 0.4 | 0.4 | 0.4 | 0.4 | 0.4 | 0.4 |
| Weight Averaged | 2.83 | 2.77 | 2.7 | 2.63 | 2.56 | 2.06 | 1.79 | 1.53 | 1.18 |
| LogP | | | | | | | | | |

(1) Rapi-cure ™ CHVE is actually CHDVE available from International Specialty Products.
Ink 9 is merely a repeat of Ink 1.

Step (III): Preparation of Inks 18 to 23

Inks were prepared having the formulations described in Table 6. These inks had at least one CCC having at least one vinyl ether group and at least one RCC having at least one acrylate group. These inks were prepared by stages a) to e) described below.

Stage a)

The cationically curable compound (1) the radically curable compound (3) and the adhesion promoters (7) and (8) were mixed together by stirring at approximately 25° C. for 1 hr. This resulted in a reactive mixture.

Stage b)

The millbases (9) and (10) were then added to the reactive mixture resulting from stage a).

Stage c)

The cationic initiator (2), the radical initiators (4) to (5) and the sensitizer (6) were mixed in the dark with the above mixture resulting from stage b) in the absence of light.

Stage d)

The surfactant (11) and the inhibitor (12) were mixed with the above mixture resulting from stage c).

Stage e)

The mixture resulting from stage d) was then cascade filtered through a series of filters having pore sizes of 10, 6, 4.5, 2.5 and 1.2 microns respectively. This resulted in the Inks 18 to 23.

TABLE 6

| Component | Ink 18 | Ink 19 | Ink 20 | Ink 21 | Ink 22 | Ink 23 |
|---|---|---|---|---|---|---|
| Type (Acrylate = A, vinyl | A/VE | A/VE | A/VE | A/VE | A/VE | A/VE |
| ether = VE, oxetane = O, epoxy = E) | | | | | | |
| Cationically curable | | | | | | |
| compound | | | | | | |
| (1) CHDVE | 20.0 | 25.0 | 20.0 | 20.0 | 20.0 | 20.0 |
| Cationic initiator | | | | | | |
| (2) Irgacure ™ 250 | 2.0 | 2.0 | 2.0 | 2.0 | 2.0 | 2.0 |
| Radically curable | | | | | | |
| compound | | | | | | |
| (3) Sartomer ™ 506 | 50.6 | 45.6 | 50.6 | 45.6 | 45.6 | 45.6 |
| Radical Initiator | | | | | | |
| (4) Speedcure ™ ITX | 2.0 | 2.0 | 2.0 | 2.0 | 2.0 | 2.0 |
| (5) Irgacure ™ 369 | 4.0 | 4.0 | 4.0 | 4.0 | 4.0 | 4.0 |
| Sensitizer | | | | | | |
| (6) Speedcure ™ EHA | 4.0 | 4.0 | 4.0 | 4.0 | 4.0 | 4.0 |
| Adhesion Promoter | | | | | | |
| (7) Photomer ™ 5429 | 15.0 | 15.0 | 15.0 | 15.0 | 15.0 | 15.0 |
| (8) Acrylic acid | | | | 5.0 | 5.0 | 5.0 |
| Colorant | | | | | | |
| (9) Cyan millbase 1 | 1.5 | 1.5 | 1.5 | 1.5 | 1.5 | 1.5 |
| (10) Yellow millbase 1 | 0.5 | 0.5 | 0.5 | 0.5 | 0.5 | 0.5 |
| Surfactant | | | | | | |
| (11) Tegorad ™ 2200 | 0.4 | 0.4 | 0.4 | 0.4 | 0.4 | 0.4 |
| Inhibitor | | | | | | |
| (12) Hydroquinone | | | | | 0.05 | 0.02 |

Step (IV): Preparation of Inks 24 to 47

Inks were prepared having the formulations described in Table 7. These inks had different amounts of different oxetanes. Inks 24 to 33 comprise only CCCs having at least one oxetane group. Inks 34 to 47 comprise a CCC having at least one oxetane group and a CCC having at least one epoxy group. These inks were prepared by Stages a) to e) described below:

Stage a)

The cationically curable compounds (1) to (4) were mixed together by stirring at approximately 25° C. for 1 hr. This resulted in a reactive mixture.

Stage b)

The millbase (8) was then added to the reactive mixture resulting from stage a).

Stage c)

The cationic initiator (5) or (6) and the radical initiator (7) or (8) were mixed in the dark with the above mixture resulting from stage b).

Stage d)

The surfactant (9) was mixed with the above mixture resulting from stage c).

Stage e)

The resulting mixture from stage d) was then cascade filtered through a series of filters having pore sizes of 10, 6, 4.5, 2.5 and 1.2 microns respectively. This resulted in the Inks 24 to 47.

TABLE 7

| | Ink | Ink | Ink | Ink | Ink | Ink | Ink | Ink | Ink | Ink |
|---|---|---|---|---|---|---|---|---|---|---|
| Component | 24 | 25 | 26 | 27 | 28 | 29 | 30 | 31 | 32 | 33 |
| Type (Acrylate = A, vinyl | O | O | O | O | O | O | O | O | O | O |
| ether = VE, oxetane = O, | | | | | | | | | | |
| epoxy = E) | | | | | | | | | | |
| (1) OXT 101 | 93.6 | | | 46.8 | 46.8 | | | | | |
| (2) OXT 221 | | 93.6 | | 46.8 | | 46.8 | 93.6 | 46.8 | 93.6 | 46.8 |
| (3) OXT 212 | | | 93.6 | | 46.8 | 46.8 | | 46.8 | | 46.8 |
| (4) Epikote ™ 828 | | | | | | | | | | |
| Cationic initiator | | | | | | | | | | |
| (5) Irgacure ™ 250 | 3.0 | 3.0 | 3.0 | 3.0 | 3.0 | 3.0 | | | 3.0 | 3.0 |
| (6) HTPIA | | | | | | | 3.0 | 3.0 | | |
| Radical initiator | | | | | | | | | | |
| (7) Darocure ™ 1173 | 1.0 | 1.0 | 1.0 | 1.0 | 1.0 | 1.0 | 1.0 | 1.0 | | |
| (8) Speedcure ™ ITX | | | | | | | | | 1.0 | 1.0 |
| Colorant | | | | | | | | | | |
| (8) Cyan millbase 1 | 2.0 | 2.0 | 2.0 | 2.0 | 2.0 | 2.0 | 2.0 | 2.0 | 2.0 | 2.0 |
| Surfactant | | | | | | | | | | |
| (9) Tegorad ™ 2200 | 0.4 | 0.4 | 0.4 | 0.4 | 0.4 | 0.4 | 0.4 | 0.4 | 0.4 | 0.4 |
| | Ink | Ink | Ink | Ink | Ink | Ink | Ink | Ink | Ink | Ink |
| Component | 34 | 35 | 36 | 37 | 38 | 39 | 40 | 41 | 42 | 43 |
| Type (Acrylate = A, vinyl | O/E | O/E | O/E | O/E | O/E | O/E | O/E | O/E | O/E | O/E |
| ether = VE, oxetane = O, | | | | | | | | | | |
| epoxy = E) | | | | | | | | | | |
| Cationically curable | | | | | | | | | | |
| compound | | | | | | | | | | |
| (1) OXT 101 | | | | | | 83.6 | 73.6 | 63.6 | 53.6 | 43.6 |
| (2) OXT 221 | 83.6 | 73.6 | 63.6 | 53.6 | 43.6 | | | | | |
| (3) OXT 212 | | | | | | | | | | |
| (4) Epikote ™ 828 | 10.0 | 20.0 | 30.0 | 40.0 | 50.0 | 10.0 | 20.0 | 30.0 | 40.0 | 50.0 |
| Cationic initiator | | | | | | | | | | |
| (5) Irgacure ™ 250 | 3.0 | 3.0 | 3.0 | 3.0 | 3.0 | 3.0 | 3.0 | 3.0 | 3.0 | 3.0 |
| (6) HTPIA | | | | | | | | | | |
| Radical initiator | | | | | | | | | | |
| (7) Darocure ™ 1173 | 1.0 | 1.0 | 1.0 | 1.0 | 1.0 | 1.0 | 1.0 | 1.0 | 1.0 | 1.0 |
| (8) Speedcure ™ ITX | | | | | | | | | | |
| Colorant | | | | | | | | | | |
| (8) Cyan millbase 1 | 2.0 | 2.0 | 2.0 | 2.0 | 2.0 | 2.0 | 2.0 | 2.0 | 2.0 | 2.0 |
| Surfactant | | | | | | | | | | |
| (9) Tegorad ™ 2200 | 0.4 | 0.4 | 0.4 | 0.4 | 0.4 | 0.4 | 0.4 | 0.4 | 0.4 | 0.4 |

| | Ink | Ink | Ink | Ink |
|---|---|---|---|---|
| Component | 44 | 45 | 46 | 47 |
| Type (Acrylate = A, | O/E | O/E | O/E | O/E |
| vinyl ether = VE, | | | | |
| oxetane = O, epoxy = E) | | | | |
| Cationically | | | | |
| curable compound | | | | |
| (1) OXT 101 | | | | |
| (2) OXT 221 | 32.0 | 37.0 | 42.0 | 47.0 |
| (3) OXT 212 | 31.6 | 26.6 | 21.6 | 16.6 |
| (4) Epikote ™ 828 | 30.0 | 30.0 | 30.0 | 30.0 |
| Cationic initiator | | | | |
| (5) Irgacure ™ 250 | 3.0 | 3.0 | 3.0 | 3.0 |
| (6) HTPIA | | | | |
| Radical initiator | | | | |
| (7) Darocure ™ 1173 | 1.0 | 1.0 | 1.0 | 1.0 |
| (8) Speedcure ™ ITX | | | | |
| Colorant | | | | |
| (8) Cyan millbase 1 | 2.0 | 2.0 | 2.0 | 2.0 |
| Surfactant | | | | |
| (9) Tegorad ™ 2200 | 0.4 | 0.4 | 0.4 | 0.4 |

Step (V): Preparation of Dielectric Boards Having a Cured Solder Mask

FR4 dielectric boards laminated with 30 micron thick copper sheet on the surface of the board were prepared using Inks 9 to 23 in the manner described in Example 1, step (IV) with the exception that the Inks 9 to 23 were applied to the copper surface of the FR4 dielectric boards by means of a 25 micron K-bar.

Step (VI): Testing of Dielectric Boards Having a Cured Solder Mask

The resistance of the solder mask to borohydride solution was measured by immersing the dielectric board into a fresh solution of 10% or 20% by weight potassium borohydride in water. The solution had a pH of about 11 and the immersion was performed at a temperature of 70° C. After immersion the solder mask was visually assessed for damage and rated wherein damage in less than 1 minute is given a rating of poor, damage between 1 to 2 minutes is given a rating of moderate and no damage after 2 minutes is given a rating of good performance.

The resistance of the solder mask to hypophosphite solution was measured by immersing the dielectric board into a fresh solution of 20% by weight sodium hypophosphite at a pH of about 6. The time for the immersion was 20 minutes at a temperature of 80° C. After immersion the solder mask was visually assessed for damage and rated visually from poor (O) to excellent (5).

Otherwise the test methods and preparation methods were as described in Example 1.

The LogP value (6) was calculated using equation (1).

Step (VII): Test Results for Inks 9 to 14

TABLE 8

| Test | Ink 9 | Ink 10 | Ink 11 | Ink 12 | Ink 13 | Ink 14 |
|---|---|---|---|---|---|---|
| (1) Viscosity | 12.8 | 12.8 | 12.6 | 12.5 | 13.6 | 21.2 |
| at 45° C. cPs | | | | | | |
| (mPa · s) | | | | | | |
| (2) Pencil | 8H | 8H | 8H | 8H | 8H | 8H |
| Hardness | | | | | | |
| (3) Adhesion | 5 | 5 | 5 | 5 | 5 | 5 |
| on copper | | | | | | |
| (4) Resistance | 5 | 5 | 5 | 5 | 5 | 5 |
| Hypophosphite | | | | | | |
| solution. | | | | | | |
| (5) Resistance to | 5 | 3.5 | 2 | 2 | 2 | 3 |
| solder | | | | | | |
| (6) Weight | 2.83 | 2.77 | 2.7 | 2.63 | 2.56 | 2.06 |
| Averaged LogP | | | | | | |

The results in Table 8 show that the solder masks resulting from an ink in which all the CCCs present had a weight averaged LogP of at least 2 had especially good solder resistance. Further, such solder masks demonstrate good pencil hardness, adhesion to copper and hypophosphite resistance.

Step (VIII): Test Results for Inks 18 to 23

The resistance of the solder mask derived from Inks 18 to 23 to borohydride solutions (1) and (2) was measured as indicated above except that the temperature for the immersion was 80° C.

Otherwise the measurements were performed by the methods as described in Example 1.

The results of these tests are shown in Table 9 below:

TABLE 9

| | Ink | Ink | | Ink | | |
|---|---|---|---|---|---|---|
| Test | 18 | 19 | Ink 20 | 21 | Ink 22 | Ink 23 |
| (1) Resistance to 20% | good | good | good | — | good | Good |
| KBH₄ | | | | | | |
| (2) Resistance to 10% | — | — | — | — | good | Good |
| KBH₄ | | | | | | |
| (3) Resistance to solder | 5 | 5 | 5 | — | 5 | 5 |
| (4) Pencil hardness | >8H | 7H | 7H | — | 7H | 7H |
| (5) Adhesion | 5 | 5 | 5 | — | 5 | 5 |
| (6) Dielectric strength | 3.1 | 3.4 | 4.0 | — | 2.5 | 3.9 |
| (kV/25 micron) | | | | | | |

The results in Table 9 show that the solder masks resulting from an ink comprising at least one CCC having at least one vinyl ether group and at least one RCC having at least one acrylate group demonstrated good pencil hardness, adhesion, borohydride resistance and hypophosphite resistance.

1. A process for making a printed circuit board having a solder mask and area(s) of exposed metal circuitry which comprises the steps:
a) applying a non-aqueous ink which is substantially free from organic solvent to a printed circuit board;
b) curing the ink by exposure to actinic radiation; and
c) optionally heating the ink;
whereby the ink is applied to selected areas of the printed circuit board by means of an ink jet printer and wherein the ink comprises:
i) a cationically curable compound; and
ii) a cationic initiator.

2. A process according to claim 1 wherein the ink comprises:
i) 0.1 to 99.9 parts of cationically curable compound; and
ii) 0.01 to 20 parts of cationic initiator;
wherein all parts are by weight.

3. A process according to claim 1 wherein the cationically curable compound has at least one vinyl ether, oxetane or epoxy group.

4. A process according to claim 1 wherein the ink comprises at least one cationically curabie compound having at least one vinyl ether group and at least one cationically curable compound having at least one epoxy group.

5. A process according to claim 4 wherein the ink comprises:
a) from 29 to 70 parts of a cationically curable compound having at least one vinyl ether group;
b) from 29 to 70 parts of a cationically curable compound having at least one epoxy group; and
c) from 1 to 10 parts of cationic initiator;
wherein the ink has a viscosity of less than 200 mPa·s at 40° C. and all parts are by weight.

6. A process according to claim 1 wherein the ink comprises at least one cationically curable compound having at least one vinyl ether group, at least one cationically curable compound having at least one epoxy group and at least one cationically curable compound having at least one oxetane group.

7. A process according to claim 6 wherein the ink comprises:
a) from 20 to 70 parts of a cationically curable compound having at least one vinyl ether group;
b) from 20 to 70 parts of a cationically curable compound having at least one epoxy group;
c) from 20 to 70 parts of a cationically curable compound having at least one oxetane group; and
d) from 1 to 10 parts of cationic initiator;
wherein the ink has a viscosity of less than 200 mPa·s at 40° C. and all parts are by weight.

8. A process according to claim 1 wherein the ink comprises at least one cationically curable compound having a LogP value of at least 2.

9. A process according to claim 1 wherein all of the cationically curable compound(s) present in the ink provide a weight averaged LogP value of at least 2.

10. A process according to claim 1 comprising an additional process step d) of metal plating one or more area(s) of the exposed metal circuitry

11. A process according to claim 10 wherein the metal plating is electroless metal plating utilising a reducing agent.

12. A process according to claim 11 wherein the reducing agent is selected from hypophosphite, hydrazine based, thiourea based, borohydride, amine borane and aldehyde/amine borane agents.

13. A process according to claim 10 wherein the metal plating is immersion or electrolytic metal plating.

14. A printed circuit board having a solder mask obtainable by the process according to claim 7.

15. A printed circuit board obtainable by a process according to claim 10.

16. A printed circuit board obtainable by a process according to claim 1 wherein the ink comprises at least two different cationically curable compounds, all of the cationically curable compounds present in the ink provide a weight averaged LogP value of at least 2.
